(19) United States
(12) Patent Application Publication
(10) Pub. No.: US 2026/0102706 A1
(43) Pub. Date: Apr. 16, 2026

(54) VIRTUAL SCENE INTERACTION DATA PROCESSING METHOD AND APPARATUS, ELECTRONIC DEVICE, COMPUTER PROGRAM PRODUCT, AND COMPUTER-READABLE STORAGE MEDIUM

(71) Applicant: TENCENT TECHNOLOGY (SHENZHEN) COMPANY LIMITED, Shenzhen (CN)

(72) Inventor: Yizhou LI, Shenzhen (CN)

(21) Appl. No.: 19/354,785

(22) Filed: Oct. 9, 2025

Related U.S. Application Data
(63) Continuation of application No. PCT/CN2024/100634, filed on Jun. 21, 2024.

(30) Foreign Application Priority Data
Sep. 28, 2023 (CN) 202311276899.5

(51) Int. Cl. A63F 13/56; A63F 13/52

(52) U.S. Cl. CPC A63F 13/56; A63F 13/52; A63F 2300/638

(57) ABSTRACT

Embodiments of this application disclose a virtual scene interaction data processing method, including displaying a virtual object and an interactive object in a virtual scene; acquiring a current pose of the virtual object at a first moment in response to the virtual object meeting, at the first moment, an interaction condition between the virtual object and the interactive object; determining a pose difference value between the current pose and a reference pose, the reference pose being an initial pose of the virtual object; determining a ratio of the pose difference value to a number of transition frames as a pose adjustment value, the number of transition frames being a number of image frames between the first moment and a second moment; and controlling the virtual object to implement, starting from the first moment, the pose adjustment value in each image frame until the second moment.

### RELATED APPLICATIONS

This application is a continuation of PCT Application No. PCT/CN2024/100634, filed on Jun. 21, 2024, which is based upon and claims priority to Chinese Patent Application No. 202311276899.5 filed on Sep. 28, 2023, which are both incorporated by reference.

### FIELD OF THE TECHNOLOGY

The present disclosure relates to human-computer interaction technologies, and in particular, to a virtual scene interaction data processing method and apparatus, an electronic device, a computer program product, and a computer-readable storage medium.

### BACKGROUND OF THE DISCLOSURE

With the development of computer technologies, an electronic device can implement a richer and more vivid virtual scene. A virtual scene refers to a digital scene delineated by a computer by using a digital communication technology. A user (or a player) may achieve an effect of complete virtualization (for example, virtual reality) or achieve an effect of partial virtualization (for example, augmented reality) in aspects such as visual and auditory aspects in the virtual scene, and may control objects in the virtual scene to interact, to obtain a feedback.

When a virtual object needs to be controlled to move from a current position to another position in a virtual scene, a related technology is generally implemented by controlling the virtual object to move directly. For example, the virtual object is controlled to forcibly move from the current position to another position, leading to rigid actions of the virtual object, and affecting the smoothness of image display on a terminal device.

### SUMMARY

Embodiments of this application provide a virtual scene interaction data processing method and apparatus, an electronic device, a computer program product, and a computer-readable storage medium, which can allow interaction actions in the virtual scene to transition naturally and smoothly.

Technical solutions of some embodiments of this application are implemented as follows:

Some embodiments of this application provide a virtual scene interaction data processing method, the method being executed by an electronic device, and including displaying a virtual object and an interactive object in a virtual scene; acquiring a current pose of the virtual object at a first moment, in response to the virtual object meeting, at the first moment, an interaction condition between the virtual object and the interactive object; determining a pose difference value between the current pose and a reference pose, the reference pose being an initial pose of the virtual object during interaction with the interactive object; determining a ratio of the pose difference value to a number of transition frames as a pose adjustment value, the number of transition frames being a number of image frames between the first moment and a second moment; and controlling the virtual object to implement, starting from the first moment, the pose adjustment value in each image frame until the second moment.

Some embodiments of this application provide an electronic device, including: a memory, configured to store computer-executable instructions; and a processor, configured to implement the virtual scene interaction data processing method provided in some embodiments of this application when executing the computer-executable instructions stored in the memory.

Some embodiments of this application provide a non-transitory computer-readable storage medium, having a computer program or computer-executable instructions stored therein, the computer program or the computer-executable instructions being configured for implementing the virtual scene interaction data processing method provided in some embodiments of this application when being executed by a processor.

In embodiments of the present application, through gradual transforming of the current pose of the virtual object at the first moment to the reference pose at the second moment frame by frame, an interaction process between the virtual object and the interactive object becomes more natural, thereby improving smoothness of image display on the terminal device. In addition, the virtual object is adjusted to the reference pose, making triggering of an interaction control easier, thereby avoiding a plurality of triggers and reducing resource waste.

### BRIEF DESCRIPTION OF THE DRAWINGS

FIG. 1A is a schematic diagram of a first application mode of a virtual scene interaction data processing method according to embodiments of this application.

FIG. 1B is a schematic diagram of a second application mode of a virtual scene interaction data processing method according to embodiments of this application.

FIG. 2 is a schematic structural diagram of a terminal device 400 according to embodiments of this application.

FIG. 3A is a first flowchart of a virtual scene interaction data processing method according to embodiments of this application.

FIG. 3B is a second flowchart of a virtual scene interaction data processing method according to embodiments of this application.

FIG. 3C is a third flowchart of a virtual scene interaction data processing method according to embodiments of this application.

FIG. 3D is a fourth flowchart of a virtual scene interaction data processing method according to embodiments of this application.

FIG. 3E is a fifth flowchart of a virtual scene interaction data processing method according to embodiments of this application.

FIG. 3F is a sixth flowchart of a virtual scene interaction data processing method according to embodiments of this application.

FIG. 3G is a seventh flowchart of a virtual scene interaction data processing method according to embodiments of this application.

FIG. 3H is an eighth flowchart of a virtual scene interaction data processing method according to embodiments of this application.

FIG. 4A is a first schematic diagram of an application scene of a virtual scene interaction data processing method according to embodiments of this application.

FIG. 4B is a second schematic diagram of an application scene of a virtual scene interaction data processing method according to embodiments of this application.

FIG. 4C is a third schematic diagram of an application scene of a virtual scene interaction data processing method according to embodiments of this application.

FIG. 4D is a fourth schematic diagram of an application scene of a virtual scene interaction data processing method according to embodiments of this application.

FIG. 4E is a fifth schematic diagram of an application scene of a virtual scene interaction data processing method according to embodiments of this application.

FIG. 5 is a flowchart of an application scene of a virtual scene interaction data processing method according to embodiments of this application.

FIG. 6 is a schematic diagram of a pose of a virtual object in a world coordinate system according to embodiments of this application.

### DESCRIPTION OF EMBODIMENTS

To make objectives, technical solutions, and advantages of this application clearer, the following further describes this application in detail with accompanying drawings. The embodiments described are not to be construed as limitation on this application. All other embodiments obtained by a person of ordinary skill in the art without creative efforts are to fall within the protection scope of this application.

“Some embodiments” involved in the following description describe a subset of all possible embodiments. However, “some embodiments” may be same or different subsets of all the possible embodiments, and may be combined with each other when there is no conflict.

In the following description, the terms “first”, “second”, and “third” are merely intended to distinguish between similar objects rather than describe specific orders. The terms “first”, “second”, and “third” may, where permitted, be interchangeable in a particular order or sequence, so that embodiments of this application described herein may be performed in an order other than that illustrated or described herein.

During application of the related data acquisition processing in embodiments of this application, informed consent or independent consent of the subject of personal information is to be obtained strictly according to requirements of relevant laws and regulations, and subsequent data use and processing behaviors are performed within the laws and regulations and the authorization scope of the subject of personal information.

Unless otherwise defined, meanings of all technical and scientific terms used in embodiments of this specification are the same as those usually understood by a person skilled in the art. Terms used in some embodiments of this application are merely intended to describe some embodiments of this application, but are not intended to limit this application.

Before some embodiments of this application are further described in detail, nouns and terms involved in some embodiments of this application are described, and the following explanations are applicable to the nouns and terms involved in some embodiments of this application.

1) The virtual scene is a scene displayed (or provided) when the application runs on the terminal device, which is distinct from the real world. The virtual scene may be a simulated environment of the real world, may be a semi-simulated and semi-fictional virtual environment, or may be a purely fictional virtual environment. The virtual scene may be any one of a two-dimensional virtual scene, a 2.5-dimensional virtual scene, or a three-dimensional virtual scene. A dimension of the virtual scene is not limited to some embodiments of this application. For example, the virtual scene may include the sky, the land, and the ocean. The land may include an environment element like a desert or a city, and a user may control a virtual object to move in the virtual scene.

2) Virtual object: A movable object in a virtual scene. The movable object may be a virtual person, a virtual animal, an animation person, or the like. The virtual object may be a virtual avatar representing the user in the virtual scene, or alternatively, a user character controllable through operations performed on a client. The virtual scene may include a plurality of virtual objects. Each virtual object has a shape and a volume of the virtual object in the virtual scene, and occupies a part of space in the virtual scene.

3) An interactive object, also referred to as a non-player character (NPC), denotes any interactive human or object image within the virtual scene that is not controlled by a real player, such as artificial intelligence (AI) configured through training for battle in the virtual scene. The interactive object may be a virtual character, a virtual animal, an animation character, or the like, such as a person, an animal, a plant, an oil drum, a wall, or a stone displayed in the virtual scene. A number of the interactive objects participating in the interaction in the virtual scene may be preset, or may be dynamically determined in an operation process of the virtual scene.

4) Pose, which describes a position, a posture, and an orientation of the virtual object in a world coordinate system. The position represents coordinates of a center or reference point of the virtual object in a three-dimensional space, as generally represented by three real numbers; the posture represents a physical state that the virtual object keeps in the virtual scene, such as holding a prop or being empty-handed; and the orientation represents a direction that the virtual object faces in the three-dimensional space, which may be represented by a rotation matrix, an Euler angle, or a quaternion.

5) World coordinate system: In the virtual scene, the world coordinate system is configured for describing a position and direction of an object in the virtual scene, and mainly achieves effects of displaying three-dimensional coordinates of a target object and determining a position of the target object according to an origin. The origin in the world coordinate system may be a center point of the virtual scene, a transverse coordinate axis (x-axis) may be a straight line passing through the origin and being parallel to a boundary line of the virtual scene, a longitudinal coordinate axis (y-axis) is a straight line that is located in the same transverse plane as the x-axis, passes through the origin, and is perpendicular to the transverse coordinate axis, and a vertical coordinate axis is a straight line passing through the origin and being perpendicular to a plane xoy.

6) Cloud game: Cloud game is also referred to as gaming on demand, namely, an instance (briefly referred to as a game instance) that a game program is deployed and run in a server, the game instance transmits game data outputted in a running process to a page of a browser of a user terminal, and the page invokes a media component of the browser to decode the game data, and renders a real-time game picture in a game process according to a decoding result. When the page monitors an operation performed by the user in the game picture, the page reports the operation to the game instance running in the server. When game data of a response operation generated by the game instance is received, the decoding and rendering process is repeated, so that the change of the game picture according to the operation of the user is presented on the page.

That is to say, a cloud game is an online gaming technology based on a cloud computing technology. The cloud gaming technology enables a thin client with relatively limited graphics processing and data computing capabilities to run high-quality games. In a cloud game scene, a game is not run in a user terminal (for example, a player game terminal), but is run in a cloud server, and the cloud server renders the game scene into an audio and video stream and transmits the audio and video stream to the user terminal by using a network. In this way, the user terminal does not need to have a strong graphic operation capability and a data processing capability, and only needs to have a basic streaming media play capability and a capability of acquiring player input instructions and transmitting the player input instructions to the cloud server.

7) An interaction condition refers to a necessary condition that needs to be met before interaction (for example, information exchange and interaction) is performed between the virtual object and the interactive object. For example, the interaction condition may include: a distance between the virtual object and the interactive object is less than or equal to a distance threshold at a first moment, or operation instructions for triggering a control prop are received at the first moment, the control prop being configured to control the interactive object to interact with the virtual object.

In an interaction solution of the virtual scene in the related technology, generally, a current pose of the virtual object is forcibly switched to a reference pose, without a transition process, resulting in a rigid action of the virtual object and making an action switching process unnatural.

An applicant finds that the pose of the virtual object cannot be naturally switched according to an interaction processing method in the related technology. With respect to the above problem, embodiments of this application provide a virtual scene interaction data processing method, which allows for natural and smooth transition in interaction actions in the virtual scene.

Some embodiments of this application provide a virtual scene interaction data processing method and apparatus, and an electronic device, a computer-readable storage medium, and a computer program product, which can allow for the more natural interaction actions between the virtual object and the interactive object. The following describes an application of the electronic device provided in some embodiments of this application. The device provided in some embodiments of this application may be implemented as various types of user terminals such as a notebook computer, a tablet computer, a desktop computer, a set-top box, a mobile device (for example, a mobile phone, a portable music player, a personal digital assistant, a dedicated message device, or a portable game device), a smartphone, a smart speaker, a smartwatch, a smart television, an on-board terminal, and an aircraft, or may be implemented as a server. Applications are described below by using examples in which the electronic device is implemented as a terminal.

In some embodiments, the virtual scene may be an environment for virtual objects (for example, game characters) to interact. For example, the game characters fight against each other in the virtual scene, and interaction in the virtual scene may be performed by controlling an action of the game character, so that the user can relieve the stress in life during the game.

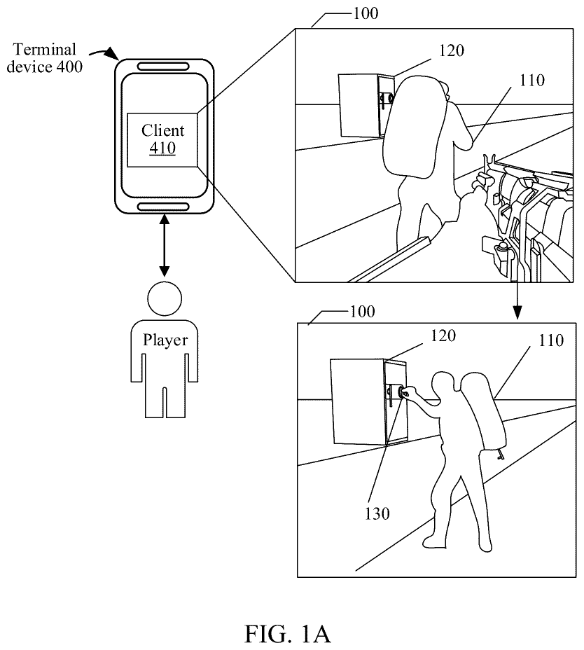

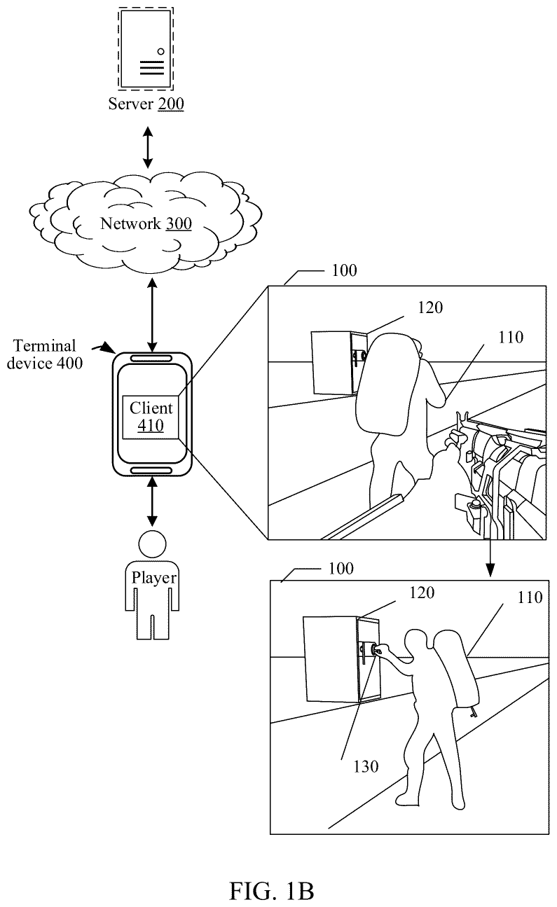

In an implementation scene, referring to FIG. 1A, FIG. 1A is a schematic diagram of a first application mode of a virtual scene interaction data processing method according to an embodiment of this application, which is applicable to some application modes in which calculation of relevant data of a virtual scene 100 is implemented completely relying on a graphics processing hardware computing capability of a terminal device 400, for example, a single-player/offline game completes the output of the virtual scene through various types of terminal devices 400 such as a smartphone, a tablet computer, and a virtual reality/augmented reality device.

When visual perception of the virtual scene 100 is formed, the terminal device 400 calculates, through graphics computing hardware, data required for display, completes loading, parsing, and rendering of the display data, and outputs a video frame capable of forming visual perception for the virtual scene on graphics output hardware, for example, displaying a two-dimensional video frame on a display screen of a smartphone, or projecting a video frame for implementing a three-dimensional display effect on lenses of augmented reality/virtual reality glasses. In addition, to enrich a perception effect, the terminal device 400 may also form one or more of auditory perception, tactile perception, motion perception, and taste perception through different hardware.

For example, the terminal device 400 runs a client 410 (for example, a single-player game application), and outputs a virtual scene including role-playing during running of the client 410. The virtual scene may be an environment for game characters to interact, for example, may be a plain, a street, a valley, or the like for the game characters to fight against each other. For example, the virtual scene 100 is displayed from a first-person perspective. In the virtual scene 100, a first virtual object 110 and an interactive object 120 are displayed. The first virtual object 110 may be a game character controlled by a user (or player), namely, the first virtual object 110 is controlled by a real user, and moves in the virtual scene 100 in response to an operation by the real user on a controller (for example, a touch screen, a voice operated switch, a keyboard, a mouse, and a joystick). For example, when the real user moves the joystick to the right, the first virtual object 110 may move to the right in the virtual scene 100 or may stay still, jump, and control the first virtual object 110 to perform an operation such as shooting; and the interactive object 120 is a non-player character in the virtual scene 100 (for example, a box, a stone, an automobile, and other virtual props).

For example, the virtual object 110 and the interactive object 120 are displayed in the virtual scene 100. The client 410, in response to a moving operation of the virtual object 110 toward the interactive object 120 (for example, receiving a click/tap operation of a player controlling, in the virtual scene 100, the virtual object 110 to run toward the interactive object 120), displays, in the virtual scene 100, an animation in which the virtual object 110 moves toward the interactive object 120. Subsequently, when an interaction condition is met between the virtual object 110 and the interactive object 120, the client 410, in response to a trigger operation on an interaction control 130 displayed on the interactive object 120 by the virtual object 110 (for example, receiving a click/tap operation of the player on an icon 130 of the interaction control displayed in the virtual scene 100), displays an interactive animation of the virtual object 110 and the interactive object 120 in the virtual scene 100. In this way, an interaction mode of the virtual scene is enriched, and the game experience of the player is improved.

In another implementation scene, referring to FIG. 1B, FIG. 1B is a schematic diagram of a second application mode of a virtual scene interaction data processing method according to an embodiment of this application. The method is applied to a terminal device 400 and a server 200, and is applicable to an application mode in which virtual scene calculation is completed relying on a computing capability of the server 200 and the virtual scene is outputted at the terminal device 400.

Using an example in which visual perception of a virtual scene 100 is formed, the server 200 calculates display data (for example, scene data) related to the virtual scene and transmits the calculation to the terminal device 400 via a network 300, the terminal device 400 relies on graphics computing hardware to complete loading, parsing, and rendering of calculated display data, and relies on graphics output hardware to output the virtual scene to form visual perception, for example, a two-dimensional video frame may be presented on a display screen of a smartphone, or a three-dimensional video frame may be projected on lenses of augmented reality/virtual reality glasses. For perception in the form of the virtual scene, the virtual scene may be outputted through corresponding hardware of the terminal device 400, for example, auditory perception is formed by using a microphone, and tactile perception is formed by using a vibrator.

For example, the terminal device 400 runs the client 410 (for example, an online game application), implements game interaction with other users by connecting to the server 200 (for example, a game server), and the terminal device 400 outputs the virtual scene 100 of the client 410. For example, the virtual scene 100 is displayed from a first-person perspective. In the virtual scene 100, the first virtual object 110 and the interactive object 120 are displayed. The first virtual object 110 may be the game character controlled by the user, namely, the first virtual object 110 is controlled by the real user, and moves in the virtual scene 100 in response to the operation by the real user on the controller (for example, the touch screen, the voice operated switch, the keyboard, the mouse, and the joystick). For example, when the real user moves the joystick to the right, the first virtual object 110 may move to the right in the virtual scene 100 or may stay still, jump, and control the first virtual object 110 to perform the operation such as shooting; and the interactive object 120 is the non-player character in the virtual scene 100 (for example, the box, the stone, the automobile, and other virtual props).

For example, the virtual object 110 and the interactive object 120 are displayed in the virtual scene 100. The client 410, in response to a moving operation of the virtual object 110 toward the interactive object 120 (for example, receiving a click/tap operation of a player controlling, in the virtual scene 100, the virtual object 110 to run toward the interactive object 120), displays, in the virtual scene 100, an animation in which the virtual object 110 moves toward the interactive object 120. Subsequently, when an interaction condition is met between the virtual object 110 and the interactive object 120, the client 410, in response to a trigger operation on an interaction control 130 displayed on the interactive object 120 by the virtual object 110 (for example, receiving a click/tap operation of the player on an icon 130 of the interaction control displayed in the virtual scene 100), displays an interactive animation of the virtual object 110 and the interactive object 120 in the virtual scene 100. In this way, an interaction mode of the virtual scene is enriched, and the game experience of the player is improved.

In some embodiments, the terminal device or the server may implement the virtual scene interaction data processing method provided in embodiments of this application by running various computer-executable instructions or a computer program. For example, the computer-executable instructions may be a microprogram-level command, machine instructions, or software instructions. The computer program may be a native program or a software module in an operating system; may be a native application (APP), namely, a program that needs to be installed in an operating system to run; or may be a mini program that may be embedded in any APP, namely, a program that only needs to be downloaded into a browser environment to run. To sum up, the computer-executable instructions may be instructions in any form, and the foregoing computer program may be an application, a module, or a plug-in in any form.

For example, the computer program is an application. In one embodiment, the terminal device 400 installs and runs an application that supports a virtual scene. The application may be any one of a first-person shooting game (FPS), a third-person shooting game, a virtual reality application, a three-dimensional map program, a card strategy game, a sports game, or a multiplayer shooter survival game. The user uses the terminal device 400 to operate the virtual object in the virtual scene to perform an action. The action includes, but is not limited to, at least one of body posture adjustment, crawling, walking, running, cycling, jumping, driving, picking, shooting, attacking, throwing, and virtual architecture building. For example, the virtual character may be a virtual person, such as a simulated person role or an animated person role.

A solution for cooperative implementation of the terminal device and the server mainly involves two game modes, namely, a local game mode and a cloud game mode. The local game mode means that the terminal device and the server cooperatively run game logic processing. Some operation instructions inputted by a player into the terminal device are used by the terminal device to run game logic processing, and some other operation instructions are used by the server to run game logic processing. In addition, game logic processing run by the server is usually more complex and needs to consume more computing power. The cloud game mode means that game logic processing is completely run by the server (for example, a cloud server), and game scene data is rendered into audio and video streams by the cloud server, and the audio and video streams are transmitted to the terminal device via a network for display. That is to say, the terminal device only needs to have a basic streaming media playback capability and a capability of acquiring operation instructions of a player and transmitting the operation instructions to the server.

Some other embodiments of this application may be implemented with the help of the artificial intelligence (AI) technology, which is a theory, method, technology, and application system that uses a digital computer or a machine controlled by the digital computer to simulate, extend, and expand human intelligence, perceive an environment, acquire knowledge, and use knowledge to obtain an optimal result. In other words, artificial intelligence is a comprehensive technology in computer science, and attempts to understand essence of intelligence and produce a new intelligent machine that can react in a mode similar to human intelligence. Artificial intelligence is to research design principles and implementation methods of various intelligent machines, so that the machines have functions of perception, reasoning, and decision-making.

AI technology is a comprehensive discipline and covers a wide range of fields, and includes both technologies at the hardware level and technologies at the software level. Basic artificial intelligence technologies generally include a sensor, a dedicated artificial intelligence chip, cloud computing, distributed storage, a big data processing technology, a pre-trained model technology, an operating/interaction system, and electromechanical integration. The pre-training model is also referred to as a big model or a basic model, and may be widely used in downstream tasks in various directions of artificial intelligence after fine-tuning.

Artificial intelligence software technologies mainly include several major directions, such as a computer vision technology, a speech processing technology, a natural language processing technology, and machine learning/deep learning.

In some embodiments, the server 200 may be an independent physical server, or may be a server cluster formed by a plurality of physical servers or a distributed system, or may be a cloud server that provides basic cloud computing services such as a cloud service, a cloud database, cloud computing, a cloud function, cloud storage, a network service, cloud communication, a middleware service, a domain name service, a security service, a content delivery network (CDN), big data, and an AI platform. The terminal device 400 may be a smart phone, a tablet computer, a notebook computer, a desktop computer, a smart speaker, a smartwatch, an on-board terminal, or the like, which is not limited thereto. The terminal and the server may be connected directly or indirectly in a wired or wireless communication mode, which is not limited to some embodiments of this application.

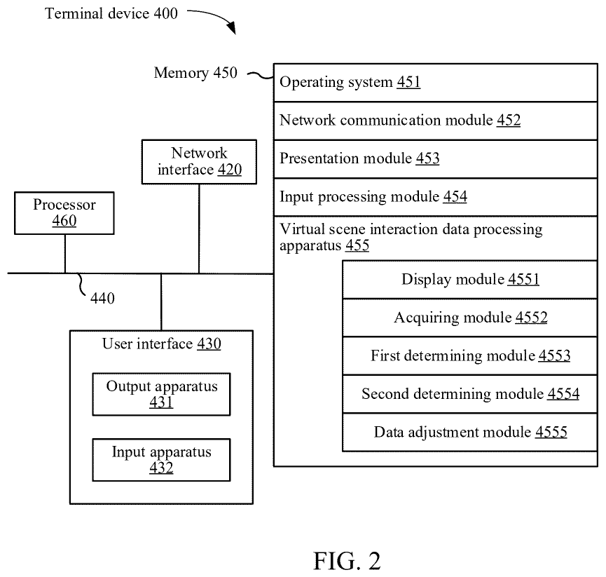

Referring to FIG. 2, FIG. 2 is a schematic structural diagram of a terminal device 400 according to embodiments of this application. The terminal device 400 shown in FIG. 2 includes at least one processor 460, a memory 450, at least one network interface 420, and a user interface 430. Components in the terminal device 400 are coupled together by using a bus system 440. The bus system 440 is configured to implement connection and communication between these components. In addition to a data bus, the bus system 440 further includes a power bus, a control bus, and a state signal bus. However, for ease of clear description, all types of buses are marked as the bus system 440 in FIG. 2.

The processor 460 may be an integrated circuit chip with signal processing capabilities, such as a general-purpose processor, a digital signal processor (DSP), or other programmable logic devices, discrete gates, transistor logic devices, or discrete hardware components. The general-purpose processor may be a microprocessor, any conventional processor, or the like.

The user interface 430 includes one or more output apparatuses 431 capable of presenting media content, which includes at least one of the following: one or more loudspeakers and one or more visual display screens. The user interface 430 further includes one or more input apparatuses 432, which includes user interface members that help user input, such as a keyboard, a mouse, a microphone, a touch display screen, a camera, and other input buttons and controls.

The memory 450 may be a removable memory, an irremovable memory, or a combination of the two. Hardware devices include a solid memory, a hard disk drive, and an optical disk drive. In an embodiment, the memory 450 includes one or more storage devices physically located away from the processor 460.

The memory 450 includes a volatile memory or a non-volatile memory, or may include both a volatile memory and a non-volatile memory. The non-volatile memory may be a read-only memory (ROM), and the volatile memory may be a random access memory (RAM). The memory 450 described in some embodiments of this application aims to include any suitable type of memories.

In some embodiments, the memory 450 can store data to support various operations. Examples of the data include a program, a module, and a data structure, or a subset or a superset thereof, which are described below.

An operating system 451 includes system programs configured for processing various basic system services and execute hardware-related tasks, for example, a framework layer, a core library layer, and a driver layer, for implementing various basic services and processing hardware-based tasks;

A network communication module 452 is configured to connect to other computer devices via one or more (wired or wireless) network interfaces of 420. The network interfaces 420 include Bluetooth, Wi-Fi, and universal serial bus (USB);

A presentation module 453 is configured to enable presentation of information through the one or more output devices 431 (for example, display screens or speakers) associated with the user interface 430 (for example, a user interface configured to operate a peripheral device and display content and information); and An input processing module 454 is configured to detect one or more user inputs or interactions from one of the one or more input devices 432 and translate the detected inputs or interactions.

In some embodiments, the apparatus provided in some embodiments of this application may be implemented by software. FIG. 2 shows a virtual scene interaction data processing apparatus 455 stored in a memory 450, which may be software in a form of a program and a plug-in, and includes following software modules: a display module 4551, an acquiring module 4552, a first determining module 4553, a second determining module 4554, and a data adjustment module 4555. The modules are logical and may be combined in different modes or further split based on to-be-implemented functions. Functions of the modules are described below.

The virtual scene interaction data processing method provided in some embodiments of this application is described with reference to an application and implementation of the terminal device provided in some embodiments of this application.

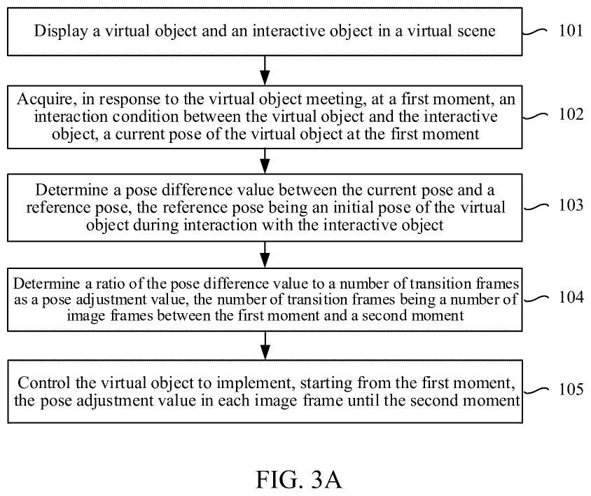

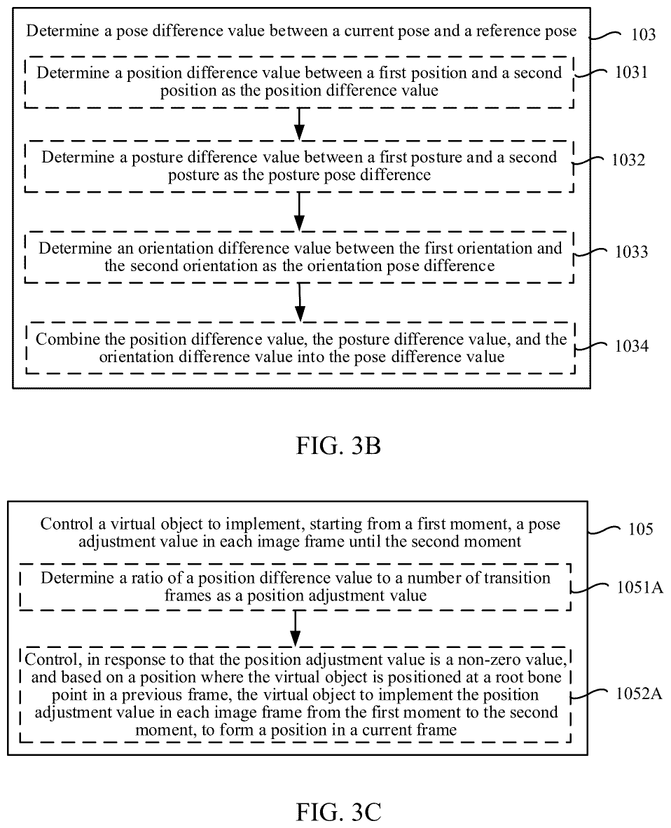

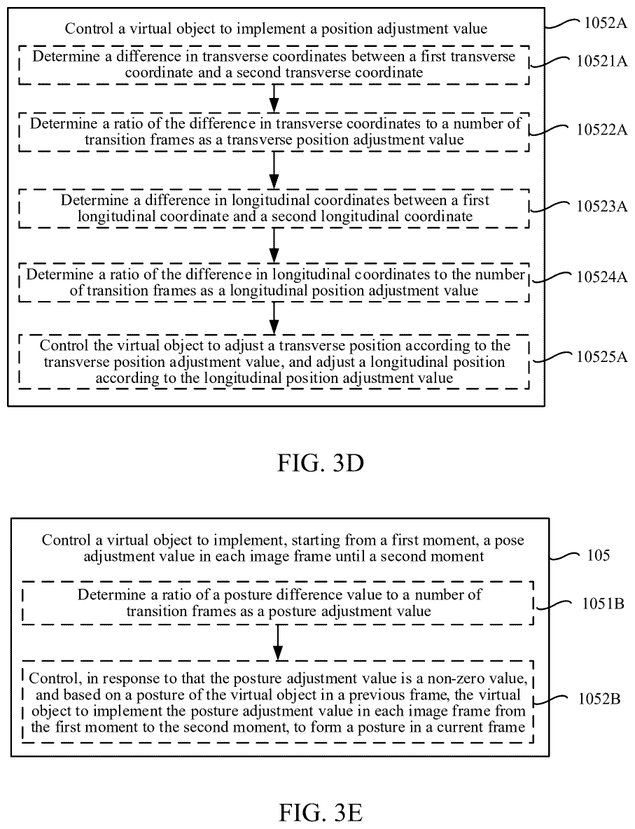

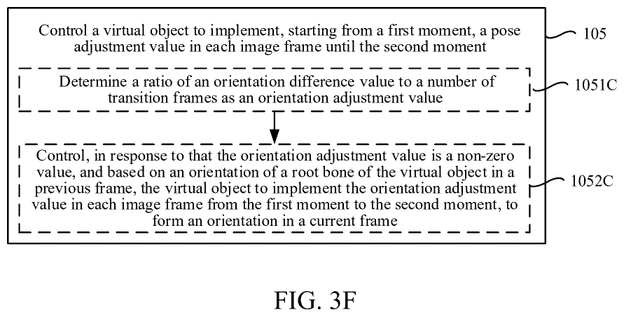

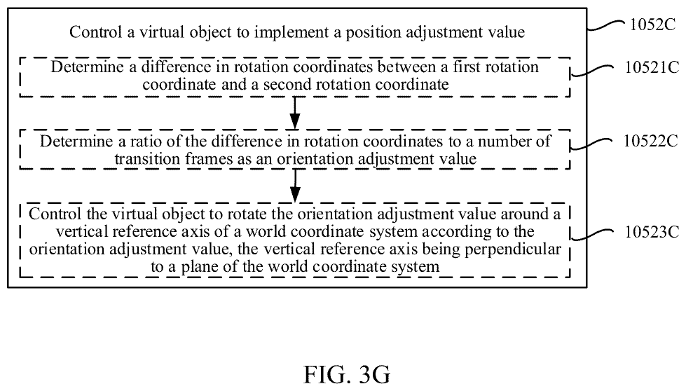

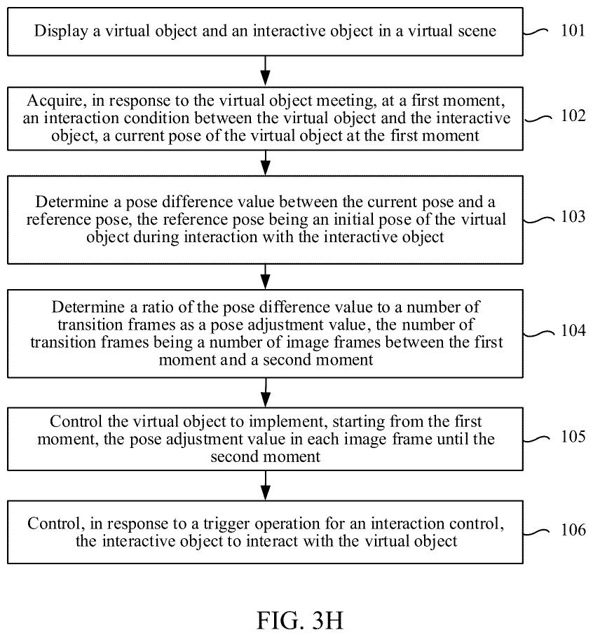

Referring to FIG. 3A, FIG. 3A is a first flowchart of a virtual scene interaction data processing method according to some embodiments of this application. The method is described with reference to operations shown in FIG. 3A, where the terminal device serves as an execution entity.

In operation 101, the virtual object and the interactive object are displayed in the virtual scene.

In some embodiments, the virtual scene may be an online game scene, the virtual object may be a player character corresponding to a user in the online game, and the interactive object may be a non-player character interacting with the player character.

In operation 102, a current pose of the virtual object at the first moment is acquired in response to the virtual object meeting, at a first moment, an interaction condition between the virtual object and the interactive object.

In some embodiments, the interaction condition includes: Meeting, by the virtual object at the first moment, that a distance between the virtual object and the interactive object is less than or equal to a distance threshold. The distance threshold can be determined in following modes: The distance threshold can be preset, or can be derived from the speed of the virtual object; and a product of the speed and the preset duration is determined as the distance threshold.

For example, a may be preset as the distance threshold, or if the speed of the virtual scene is v1, and the preset duration is t1, the distance threshold is v1 * t1.

For example, the speed of the virtual object may be of various types, such as maximum speed, minimum speed, and average speed.

For example, different moments may be set according to fixed time lengths, such as one minute, one quarter, and one hour. The first moment is a moment at which the interaction condition is met, and the second moment is a moment after a preset duration has elapsed from the first moment.

In some embodiments, the preset duration may be fixed, or may be set by the player according to a use habit of the player. For example, the player is given a duration selection range, and the player is allowed to select a duration as the preset duration.

In some other embodiments, the preset duration may be dynamic, and the preset duration may be in positive correlation with the speed (for example, the average speed) at which the player manipulates the virtual object, namely, the faster speed indicates the shorter preset duration, so that player manipulation and automatic interaction are implemented in visual effects.

For example, a relational expression between the preset duration and the speed at which the player manipulates the virtual object may be: y=ax+b, where x is the speed at which the player manipulates the virtual object, y is the preset duration, a is a positive number, and b is any real number.

In some other embodiments, the preset duration may be predicted by the machine learning model, and a training sample may be video clips of the virtual scene, including a process of switching from a non-interactive state between the virtual object and the interactive object to an interactive state between the virtual object and the interactive object; and label data may be an appropriate switching duration calibrated by the player according to a habit. A requirement of the player for the proper duration is learned by the machine learning model.

In some embodiments, before the machine learning model is called to perform prediction processing, the following processing may be further performed: acquiring the training sample; calling the initialized machine learning model based on the training sample to perform prediction processing, to obtain a prediction result; determining a loss value between the prediction result and the label data, performing back propagation based on the loss value, and updating a parameter of the machine learning model layer by layer during a back propagation process.

For example, an exemplary structure of the machine learning model provided by some embodiments of this application may include an input layer (i.e., an embedding layer), an encoding layer (which may be for example formed by a plurality of cascaded convolutional layers), a fully connected layer, and an output layer (including an activation function such as a Softmax function). After the training sample is obtained, feature information of the training sample may be inputted into the input layer for embedding processing. Then, encoding processing is performed on an embedding feature vector outputted by the input layer through the encoding layer, to obtain a hidden layer feature vector. Subsequently, full connection processing may be performed on the hidden layer feature vector through the fully connected layer. Finally, a full connection result outputted by the fully connected layer is inputted into the output layer, to perform activation processing through the output layer, so as to obtain a prediction result. After the prediction result is obtained, the prediction result and the label data pre-labeled for the training sample may be substituted into a loss function, to obtain a loss value in a particular form between the prediction result and the label data, where the particular form includes at least one of the following: a logarithmic form, an exponential form, a quadratic form, a cross entropy form, and an absolute value form; a gradient of the loss function to a model parameter is calculated by using a back propagation algorithm; the model parameter is adjusted based on the gradient and a learning rate by using a gradient descent algorithm or another optimization algorithms; and processes of forward propagation, calculation of a loss, back propagation, and parameter update are repeatedly performed until a model converges or a preset number of training rounds is reached, and the trained machine learning model is obtained.

The machine learning model according to some embodiments of this application may be a neural network model (for example, a convolutional neural network, a deep convolutional neural network, or a fully connected neural network), a decision tree model, a gradient lifting tree, a multi-layer perceptron, a support vector machine, and the like. The type of the machine learning model is not specifically limited in some embodiments of this application.

According to some embodiments of this application, the machine learning model is trained to predict the preset duration, making the predicted duration more aligned with the use habit of the player, and allowing for the rapid acquisition of the reasonable preset duration.

In some embodiments, the interaction condition includes: receiving, at the first moment, operation instructions for triggering a control prop, the control prop being configured to control the interactive object to interact with the virtual object.

In some embodiments, the second moment may be a moment at which the virtual object starts to interact with the interactive object, specifically, in two cases: 1. The second moment may be a moment that is at least the preset duration after the first moment, where the preset duration is fixed, during which the virtual object completes a pose transformation to be adjusted into a reference pose, starting from the first moment. The preset duration may be set by a game developer or set by the user. The second moment may be a moment when the preset duration ends, namely, the virtual object, having transformed into the reference pose, immediately starts to interact with the interactive object; the second moment may also be any moment after the preset duration ends, namely, the virtual object is transformed into the reference pose by the end of the preset duration, but does not directly interact with the interactive object until the second moment, which is determined by the user. 2. The second moment may alternatively be a moment at which the virtual object enters an interaction range (an area centered around the interactive object, for example, a circle, with a size depending on an influence radius of a function of the interactive object) of the interactive object, or the second moment may be a moment at which the virtual object just enters the interaction range of the interactive object. In this case, the virtual object is just transformed into the reference pose, while starting to interact with the interactive object. The second moment may alternatively be any moment after the virtual object enters the interaction range of the interactive object. The virtual object has already been transformed into the reference pose before the second moment, but does not interact with the interactive object until the second moment, which is controlled by the user.

For example, the first moment is 1:30. In the above-mentioned first case, if the preset duration is 30 minutes, the virtual object is completely transformed into the reference pose at 2:00. If the virtual object may directly start to interact with the interactive object after being transformed into the reference pose at 2:00, the second moment is 2:00. If the virtual object does not start to interact with the interactive object at 2:00, the second moment may be any moment after 2:00. In this case, the second moment is determined by the user.

For the above-mentioned second case, if the virtual object reaches the interaction range of the interactive object at 2:00, and starts to interact with the interactive object at 2:00, the second moment is 2:00. If the virtual object completes pose transformation at 1:40 and reaches the interaction range of the interactive object, and the virtual object starts to interact with the interactive object until 2:00, 2:00 is the second moment. In this case, the second moment is determined by the user.

For example, the control prop may be a remote-control unit, and the interactive object may be an aircraft or a vehicle (an airplane or an automobile) that can be remotely controlled by using the remote-control unit.

In some embodiments, before operation 102, a determination may be made as to whether the virtual object meets the interaction condition at the first moment. Display of an interaction control of the interactive object is shielded in response to the interaction condition being not met. The interaction control of the interactive object starts to be displayed in response to the interaction condition being met and from the first moment.

For example, when the interaction condition is not met, the interaction control may not be displayed on the interactive object until the virtual object meets the interaction condition.

According to some embodiments of this application, through setting of the interaction condition, the virtual object is prevented from accidentally triggering the interaction control before interacting with the interactive object. This avoids negative impacts on the game experience of the player and also prevents a plurality of triggers of the interaction control, thereby reducing resource waste.

In some embodiments, the interaction control may be always displayed in a process of interacting with the interactive object. The interaction control is in an un-triggerable state when the interaction condition is not met, or in a triggerable state when the interaction condition is met.

For example, the un-triggerable state refers to a state where the interaction control is grayed out, namely, the interaction control cannot be triggered. The interaction control remains persistently visible on the interactive object to the player at any given time. However, the interaction control becomes triggerable only when the interaction condition is met. When the interaction condition is not met, and even if the player clicks/taps the interaction control, the interaction control cannot be triggered.

In some embodiments, after meeting the interaction condition and activating the triggerable state of the interaction control, reference is made to FIG. 3H, and FIG. 3H is an eighth flowchart of the virtual scene interaction data processing method according to some embodiments of this application. An interactive operation between the virtual object and the interactive object may be implemented by operation 106 in FIG. 3H, which is described below in detail.

In operation 106: The interactive object is controlled, in response to the trigger operation for the interaction control, to interact with the virtual object.

According to some embodiments of this application, through setting of different states of the interaction control in various cases, the virtual object is prevented from accidentally triggering the interaction control before interacting with the interactive object. This avoids negative impacts on the game experience of the player and also prevents a plurality of triggers of the interaction control, thereby reducing resource waste.

In operation 103, a pose difference value between the current pose and the reference pose is determined, the reference pose being an initial pose of the virtual object during interaction with the interactive object.

In some embodiments, the current pose includes following components: a first position, a first posture, and a first orientation of the virtual object at the first moment, and the reference pose includes following components: a second position, a second posture, and a second orientation of the virtual object during an interaction (for example, a pre-produced animation representing the interaction) with the interactive object.

For example, the reference pose may be the initial pose of the virtual object during interaction with the interactive object (for example, the pre-produced animation representing the interaction). That is to say, if the virtual object starts to interact with the interactive object from the second moment, the second moment is an initial moment of the interaction, and the pose of the virtual object at the second moment includes the second position, the second posture, and the second orientation.

The reference pose may be preset according to a position, orientation, and interaction mode of the interactive object. For example, if the interactive object is a safe deposit box, when the operation of opening the safe deposit box is performed, the visual object needs to be positioned in front of the safe deposit box, facing the safe deposit box, while putting away a gun. Correspondingly, a position where the virtual object stands in front of the safe deposit box, an orientation of the virtual object facing the safe deposit box, and a posture in which the gun is put away constitute the reference pose.

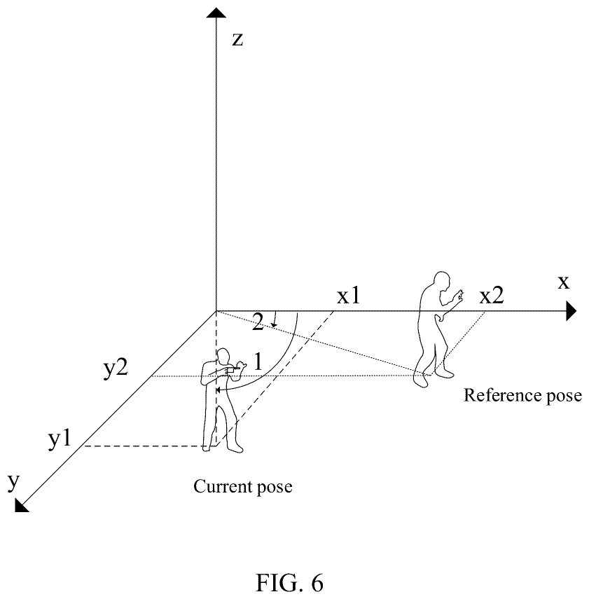

For example, the position, posture, and orientation may be represented in the world coordinate system. Referring to FIG. 6, FIG. 6 is a schematic diagram of the pose of the virtual object in the world coordinate system according to some embodiments of this application. A first position of the virtual object at the first moment is (x1, y1, 0), where x1 is a first transverse coordinate, y1 is a first longitudinal coordinate, and 0 indicates that the virtual object moves on a surface (for example, a ground or a water surface) of the virtual scene. Therefore, a vertical coordinate (a coordinate on a z-axis) is 0; the first orientation is an angle of ∠1, and the first posture corresponds to a prop-holding posture. The second position of the virtual object at the second moment is (x2, y2, 0), where x2 is a second transverse coordinate, y2 is a second longitudinal coordinate, and 0 indicates that the virtual object moves on the surface (for example, the ground or the water surface) of the virtual scene. Therefore, the vertical coordinate (the coordinate on the z-axis) is 0, the angle of the second orientation is ∠2, and the second posture corresponds to an empty-handed pose. A ground level of the virtual scene is an xoy plane, the origin is the center point of the virtual scene, the x-axis is the straight line passing through the origin and parallel to the transverse boundary line of the virtual scene, and the y-axis is the longitudinal straight line perpendicular to the x-axis.

In some embodiments, the interaction (for example, an animation including an interaction process) between the virtual object and the interactive object may start to be executed at the second moment.

In some other embodiments, the interaction between the virtual object and the interactive object may alternatively be executed at a moment after the second moment, namely, the interaction is not limited to starting from the second moment. For example, if the second moment is a moment t (in seconds), a third moment may be t+1, t+2, t+3, or the like. A specific delay may be set according to a delay requirement of the virtual scene.

For example, the virtual object has switched from the current pose at the first moment to the reference pose at the second moment. In this case, after the player directly clicks/taps the interaction control, the interaction between the virtual object and the interactive object may be started directly, or may be started 5 seconds after the second moment.

According to some embodiments of this application, start time of the interaction is freely controlled, so that the interaction process better conforms to the use habit of the player, thereby improving use experience of the player.

In some embodiments, taking the interaction (for example, the animation including the interaction process) between the virtual object and the interactive object as an example, referring to FIG. 3B, FIG. 3B is a second flowchart of the virtual scene interaction data processing method according to some embodiments of this application. Operation 103 “Determine a pose difference value between a current pose and a reference pose” in FIG. 3A may be implemented by operation 1031 to operation 1034 in FIG. 3B, which is described below in detail.

In operation 1031, a position difference value between the first position and the second position is determined as the position difference value.

In some embodiments, the first position and the second position are both three-dimensional coordinate data in the world coordinate system. Because the virtual object moves on the surface (for example, the ground or the water surface) of the virtual scene in a virtual environment, the position difference value of the virtual object in the x-axis and the y-axis is only calculated during a calculation process.

For example, if the first position is (x1, y1), and the second position is (x2, y2), a position difference value of the virtual object on the x-axis is x2-x1, and a position difference value of the virtual object on the y-axis is y2-y1.

In operation 1032, a posture difference value between the first posture and the second posture is determined as the posture difference value.

In some embodiments, the first posture may correspond to the prop-holding posture, and the second posture corresponds to the empty-handed posture. Therefore, the posture difference value represents an action change process of transforming from the prop-holding posture to the empty-handed posture.

For example, because at the second moment, the virtual object needs to interact with the interactive object, only when the second posture is in the empty-hand state, the interaction control can be triggered to complete the interaction, and posture switching to the empty-hand pose is a preparation action before the interaction.

In operation 1033, an orientation difference value between the first orientation and the second orientation is determined as the orientation difference value.

In some embodiments, the first orientation and the second orientation are both three-dimensional coordinate data in the world coordinate system. Because the virtual object moves on a ground surface of the virtual scene in the virtual environment, a difference value of rotation angles of the virtual object around the z-axis is only calculated during the calculation process as the orientation difference value.

For example, the rotation angle of the virtual object around the z-axis at the first moment is 1, the rotation angle of the virtual object around the z-axis at the second moment is 2, and the orientation difference value is 2-1.

In operation 1034, the position difference value, the posture difference value, and the orientation difference value are combined into a pose difference value.

For example, still referring to FIG. 6, the pose difference value may be divided into a transverse position difference value and a longitudinal position difference value, where the transverse position difference value is x1-x2, the longitudinal position difference value is y1-y2. The posture difference value is transformation from the prop-holding posture to the empty-handed state, and the orientation difference value is 1-2.

Still referring to FIG. 3A, in operation 104, a ratio of the pose difference value to the number of transition frames is determined as a pose adjustment value, the number of transition frames being the number of image frames between the first moment and the second moment.

In some embodiments, the ratio of the pose difference value to the number of transition frames may represent a pose change, namely, the pose adjustment value, of each frame in a process of the virtual object from the first moment to the second moment.

For example, taking the position difference value as an example, if the position of the virtual object at the first moment is (x1, y1), the position of the virtual object at the second moment is (x2, y2), and the number of transition frames from the first moment to the second moment is 60, in a case of the position difference value of the transverse coordinate being x1-x2, a transverse position adjustment value is (x1-x2)/60, and in a case of the position difference value of the longitudinal coordinates being y1-y2, a longitudinal position adjustment value is (y1-y2)/60.

For example, the number of transition frames may be obtained in a plurality of modes, for example, may be determined by setting a preset value of the number of transition frames, and for another example, may be adaptive with a frame rate of the virtual scene, namely, a product of the preset duration and the frame rate is used as the number of transition frames.

For example, the preset value may be set to 5 as the number of transition frames. Alternately, the preset duration may also be set as a, the frame rate may be set as b, and the number of transition frames is a*b.

In operation 105, the virtual object is controlled to implement the pose adjustment value, starting from the first moment in each image frame until the second moment.

In some embodiments, when current pose components include the first position, referring to FIG. 3C, FIG. 3C is a third flowchart of the virtual scene interaction data processing method according to some embodiments of this application. Operation 105 in FIG. 3A may be implemented through operation 1051A to operation 1052A in FIG. 3C, which is described below in detail.

In operation 1051A, a ratio of the position difference value to the number of transition frames is determined as a position adjustment value.

For example, if a duration from the first moment to the second moment is 1 second, which corresponds to 60 transition frames, and referring to FIG. 6, the position difference value in the transverse coordinate is x1-x2, a transverse position adjustment value is (x1-x2)/60. If the position difference value in the longitudinal coordinates is y1-y2, a longitudinal position adjustment value is (y1-y2)/60.

In operation 1052A, the virtual object is controlled, in response to that the position adjustment value is a non-zero value, and based on a position where the virtual object is positioned at a root bone point in a previous frame, to implement the position adjustment value in each image frame from the first moment to the second moment, to form a position in the current frame.

In some embodiments, a bone structure is a bone hierarchy formed by combining many consecutive bones. A first bone is referred to as a root bone, which is a key point forming the bone structure. All other bones are attached to the root bone as child bones or sibling bones. The root bone points are corresponding coordinates of the root bone within the world coordinate system.

In some embodiments, the first position includes first plane coordinates of the virtual object corresponding to the world coordinate system at the first moment, the first plane coordinates include a first transverse coordinate and a first longitudinal coordinate, the second position includes second plane coordinates of the virtual object corresponding to the world coordinate system at the second moment, and the second plane coordinates include a second transverse coordinate and a second longitudinal coordinate.

In some embodiments, referring to FIG. 3D, FIG. 3D is a fourth flowchart of the virtual scene interaction data processing method according to some embodiments of this application. Operation 1052A “control a virtual object to implement a position adjustment value” in FIG. 3C may be implemented by operation 10521A to operation 10525A in FIG. 3D, which is described below in detail.

In operation 10521A, a difference in transverse coordinates is determined between the first transverse coordinate and the second transverse coordinate.

In some embodiments, the difference in transverse coordinates is a difference value between position coordinates of the virtual object on the x-axis at the first moment and position coordinates of the virtual object on the x-axis at the second moment.

For example, still referring to FIG. 6, the first transverse coordinate of the virtual object on the x-axis at the first moment is x1, the second transverse coordinate of the virtual object on the x-axis at the second moment is x2, and the difference in transverse coordinates is x1-x2.

In operation 10522A, a ratio of the difference in transverse coordinates to the number of transition frames is determined as the transverse position adjustment value.

In some embodiments, the ratio of the difference in transverse coordinates to the number of transition frames represents a position change of each frame of the virtual object moving along the x-axis from the first moment to the second moment, namely, the transverse position adjustment value.

For example, if the duration from the first moment to the second moment is 1 second, which corresponds to 60 transition frames, and referring to FIG. 6, the difference in coordinates is x1-x2, and the transverse position adjustment value is (x1-x2)/60.

In operation 10523A, a difference in longitudinal coordinates is determined between the first longitudinal coordinate and the second longitudinal coordinate.

In some embodiments, the difference in longitudinal coordinates is a difference value between position coordinates of the virtual object on the y-axis at the first moment and position coordinates of the virtual object on the y-axis at the second moment.

For example, still referring to FIG. 6, the first longitudinal coordinate of the virtual object on the y-axis at the first moment is y1, the second longitudinal coordinate of the virtual object on the y-axis at the second moment is y2, and the difference in longitudinal coordinates is y1-y2.

In operation 10524A, a ratio of the difference in longitudinal coordinates to the number of transition frames is determined as the longitudinal position adjustment value.

For example, if the duration from the first moment to the second moment is 1 second, which corresponds to 60 transition frames, and referring to FIG. 6, the difference in longitudinal coordinates is y1-y2, and the longitudinal position adjustment value is (y1-y2)/60.

In some embodiments, the ratio of the difference in longitudinal coordinates to the number of transition frames represents a position change of each frame of the virtual object moving along the y-axis from the first moment to the second moment, namely, the longitudinal position adjustment value.

In operation 10525A, the virtual object is controlled to adjust a transverse position according to the transverse position adjustment value, and adjust a longitudinal position according to the longitudinal position adjustment value.

In some embodiments, when the current pose components include the first posture, referring to FIG. 3E, FIG. 3E is a fifth flowchart of the virtual scene interaction data processing method according to some embodiments of this application. Operation 105 in FIG. 3A may be implemented through operation 1051B to operation 1052B in FIG. 3E, which is described below in detail.

In operation 1051B, a ratio of the posture difference value to the number of transition frames is determined as a posture adjustment value.

In operation 1052B, in response to that the posture adjustment value is a non-zero value, the virtual object is controlled to implement the posture adjustment value in each image frame from the first moment to the second moment based on a posture of the virtual object in the previous frame, to form a posture in the current frame.

In some embodiments, the virtual object is in the prop-holding posture in the image frame at the first moment, and the virtual object is in the empty-handed posture in the image frame at the second moment.

For example, the virtual object may be in the prop-holding state at the first moment. After the interaction condition is met, and because the virtual object needs to interact with the interactive object from the second moment, the prop needs to be put away, and the interaction control is clicked/tapped in the empty-handed state, to complete the interaction.

According to some embodiments of this application, the posture is switched, so that the virtual object moves toward the interactive object. In a process of performing the interaction after being transformed into the reference pose, the action is smoother, and the interaction operation is completed in the empty-handed state, so that the interaction process is more realistic, and user experience is enriched.

In some embodiments, when the current pose components include the first orientation, referring to FIG. 3F, FIG. 3F is a sixth flowchart of the virtual scene interaction data processing method according to some embodiments of this application. Operation 105 in FIG. 3A may be implemented through operation 1051C to operation 1052C in FIG. 3F, which is described below in detail.

In operation 1051C, a ratio of the difference in rotation coordinates to the number of transition frames is determined as an orientation adjustment value.

In operation 1052C, in response to that the orientation adjustment value is a non-zero value, the virtual object is controlled to implement the orientation adjustment value in each image frame from the first moment to the second moment based on an orientation of a root bone of the virtual object in the previous frame, to form an orientation in the current frame.

In some embodiments, the bone structure is the bone hierarchy formed by combining the many consecutive bones. The first bone is referred to as the root bone, which is the key point forming the bone structure. All other bones are attached to the root bone as the child bones or the sibling bones.

In some embodiments, for a bone animation, a position and an orientation of a model need to be set. A position and an orientation of the root bone are set, and then a position and an orientation of each bone are calculated based on a transformation relationship between a parent bone and a child bone in the bone hierarchy, to be used as an orientation of the virtual object.

In some embodiments, the first orientation includes first rotation coordinates of the virtual object corresponding to the world coordinate system at the first moment, and the second orientation includes second rotation coordinates of the virtual object corresponding to the world coordinate system at the second moment.

For example, the first rotation coordinates may be an angle by which the virtual object rotates around the z-axis from zero degrees at the first moment. Calculation of the angle may be determined by a sense of rotation. For example, clockwise rotation is considered positive. Still referring to FIG. 6, the first orientation is an angle of ∠1, and the second orientation is an angle of ∠2.

In some embodiments, referring to FIG. 3G, FIG. 3G is a seventh flowchart of the virtual scene interaction data processing method according to some embodiments of this application. Operation 1052C in FIG. 3F may be implemented through operation 10521C to operation 10523C in FIG. 3G, which is described below in detail.

In operation 10521C, a difference in longitudinal coordinates is determined between the first rotation coordinates and the second rotation coordinates.

In some embodiments, the difference in rotation coordinates is a difference value between an angle value by which the virtual object rotates around the z-axis at the first moment and an angle value by which the virtual object rotates around the z-axis at the second moment.

For example, if the angle value by which the virtual object rotates around the z-axis at the first moment is 30 degrees, and the angle value by which the virtual object rotates around the z-axis at the second moment is 90 degrees, the difference in rotation coordinates is 60 degrees.

In operation 10522C, a ratio of the difference in rotation coordinates to the transition frame is determined as an orientation adjustment value.

In some embodiments, the ratio of the difference in rotation coordinates to the number of transition frames represents an angle change of each frame of the virtual object rotating around the z-axis from the first moment to the second moment, namely, an orientation adjustment value.

Continuing from the example of operation 10521, if the difference in rotation coordinates is 60 degrees, and the number of transition frames is 30, the orientation adjustment value is 2.

In operation 10523C, the virtual object is controlled to rotate the orientation adjustment value around a vertical reference axis of the world coordinate system according to the orientation adjustment value, the vertical reference axis being perpendicular to a plane of the world coordinate system.

In some embodiments, the sense of rotation may be clockwise or anticlockwise, with a positive value corresponding to clockwise rotation and a negative value corresponding to counterclockwise rotation. The plane of the world coordinate system includes a transverse reference axis and a longitudinal reference axis.

In some embodiments, a triggering threshold may also be elevated to require full congruence between the current pose of the virtual object that is transformed at the first moment and a preset standard pose, whereupon the interaction control becomes visible and the trigger operation is enabled.

For example, after the virtual object completes transformation to the standard pose, the interaction control is displayed on the interactive object, and interaction between the virtual object and the interactive object is completed by the trigger operation on the interaction control. When the transformation is not completed, the interaction control is not displayed.

According to some embodiments of this application, different states for the interaction controls are set in various cases, or display nodes of the interaction control are controlled to prevent the virtual object from accidentally triggering the interaction control before interacting with the interactive object. This avoids negative impacts on the game experience of the player and also prevents a plurality of triggers of the interaction control, thereby reducing resource waste.

Next, an exemplary application of some embodiments of this application in an application scene is to be described.

In a virtual game scene based on team battle, the virtual object usually needs to interact with the interactive object, to obtain the prop needed during a game process. According to the virtual scene interaction data processing method provided by some embodiments of this application, the pose adjustment value may be acquired by the pose difference value of the virtual object at the first moment and the second moment, and the current pose is adjusted according to the pose adjustment value, so that the virtual object can naturally interact with the interactive object.

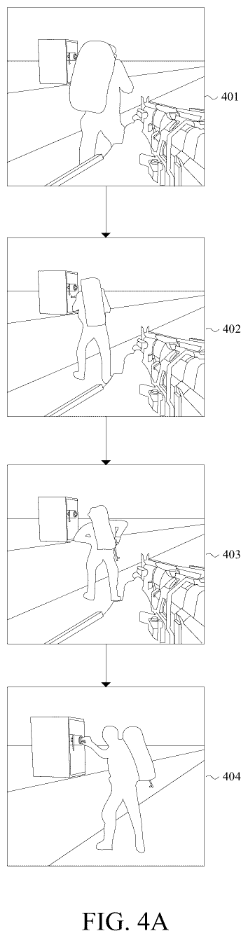

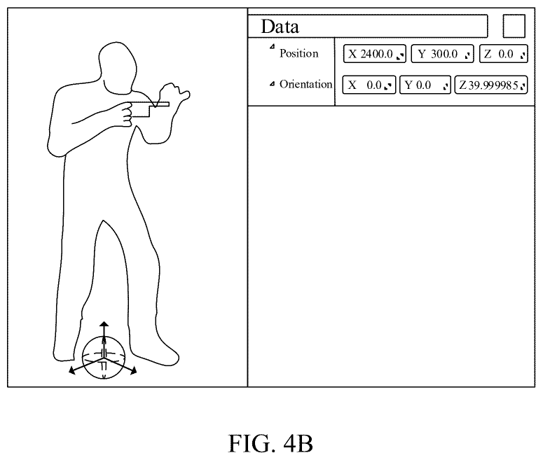

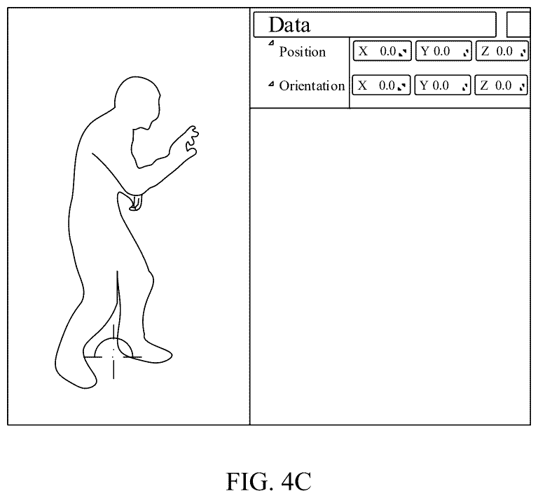

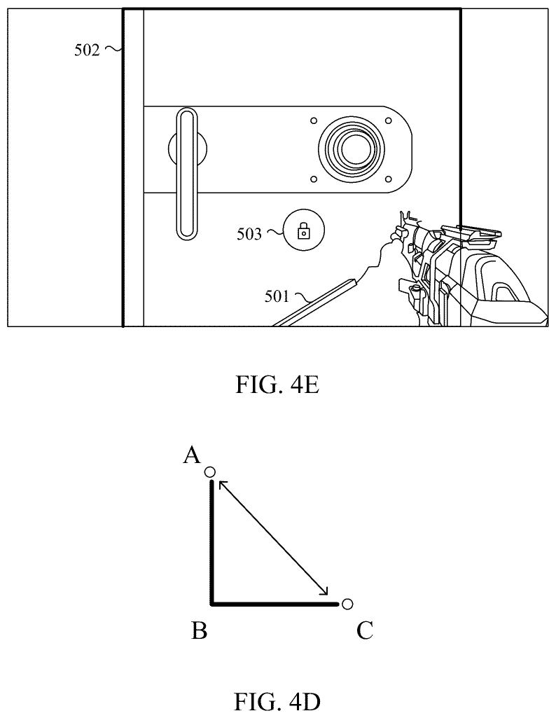

Referring to FIG. 4A, FIG. 4A is a first schematic diagram of an application scene of the virtual scene interaction data processing method according to some embodiments of this application. The application of the virtual scene interaction data processing method according to some embodiments of this application will be explained by referring to FIG. 4A.

In FIG. 4A, the current pose of the virtual object at the first moment first needs to be acquired.

Referring to FIG. 4B, FIG. 4B is a second schematic diagram of the application scene of the virtual scene interaction data processing method according to some embodiments of this application. FIG. 4B shows the current pose of the virtual object at the first moment.

In some embodiments, in the world coordinate system of the virtual object, the z-axis (i.e., a horizontal height of a position where the character stands) aligns with the reference pose at 0, as the character stands on a normal horizontal ground. However, disparities exist between values of the x-axis (transverse displacement within the horizontal plane) and the y-axis (longitudinal displacement within the horizontal plane) and those of the reference pose.

Meanwhile, rotation values of the virtual object with respect to the x-axis and the y-axis in the world coordinate system are consistent with those of the reference pose. This is because the x-axis and the y-axis control rotation of the character in a horizontal transverse direction and a horizontal longitudinal direction, but during normal game play, the virtual object in the standing pose does not rotate in these two directions. Consequently, the values of for both are 0 (degrees). The z-axis controls rotation of the virtual object in a vertical space, manifesting in-game as the rotation angle generated when the virtual object turns around, thereby exhibiting a deviation from the reference pose.

For example, the first position of the virtual object at the first moment is (2400,300, 0), where 2400 is the first transverse coordinate, 300 is the first longitudinal coordinate, the first posture at the first moment is the prop-holding posture, the first orientation at the first moment is (0, 0, 40), where 40 is the first rotation coordinate.

Still referring to FIG. 4A, the reference pose of the virtual object at the second moment further needs to be obtained.

Referring to FIG. 4C, FIG. 4C is a third schematic diagram of an application scene of the virtual scene interaction data processing method according to some embodiments of this application. FIG. 4C shows the reference pose of the virtual object at the second moment.

For example, the second position of the virtual object at the second moment is (0, 0, 0), the second posture at the second moment is the empty-handed posture, and the second orientation at the second moment is (0, 0, 0).

Still referring to FIG. 4A, a data difference (equivalent to the foregoing pose difference value) between the current pose and the reference pose is recorded, and a related transformation operation starts to be executed. A transformation process is specifically described below:

Firstly, as shown in an image frame 401 in FIG. 4A, if the first position of the virtual object is different from the standard second position for interaction, the virtual object is allowed to start to move from the first position to the second position, and complete transformation time is set to 1 s, namely, 60 frames (the number of transition frames from the first moment to the second moment).

If the current first orientation (i.e., rotation values of the world coordinates) of the virtual object is inconsistent with the second orientation of the standard interaction position, the character orientation is adjusted during the foregoing 1 s process of moving toward the second position.

Secondly, as shown in image frame 402 of FIG. 4A, the first position coordinates of the virtual object in the world coordinate system are (2400, 300, 0). Along the x-axis, the virtual object moves toward the second position at a movement speed (i.e., the position adjustment value), which is calculated as 2400/60=(40/frame). Similarly, along the y-axis, the displacement is 300/60=(5/frame). The horizontal and vertical coordinate positions of the bone of the virtual object are corrected by the movement within one second.

As mentioned above, based on a difference between the rotation values of the coordinates, if the z-axis rotation coordinates at the second moment are 0, while the rotation coordinates of the virtual object at the first moment are 40 (degrees), during the displacement process, rotation displacement of 40/60=(0.6666 (degrees)/frame) is generated along the z-axis, and rotation coordinates of the bone of the character are corrected (i.e., adjusting orientation adjustment) by the movement within one second.

Sequentially, as shown in an image frame 403 in FIG. 4A, if the virtual object is in the prop-holding state, and the interaction is triggered, the virtual object needs to be empty-handed. In a 1 s process of moving to the second position, the virtual object is controlled to switch from the prop-holding state to the empty-handed state, and the virtual object has already transformed from the current pose to the reference pose.

Finally, among the foregoing three items, if the relevant bone parameters of the virtual object meet one or two of the items, the transformation operation related to the satisfied item is not executed. If world displacement coordinates of the root bone point of the virtual object are correct (i.e., the first item, the current position of the virtual object), no position transformation is performed, and only the world rotation value (orientation) and the posture are transformed. After transformations in the three items are completed, as shown in an image frame 404 in FIG. 4A, only when the relevant bone parameters and the posture of the virtual object are completely the same as the first frame of the standard interaction actions, the virtual object triggers the interaction control and starts to play the interaction actions.

Referring to FIG. 4D, FIG. 4D is a fourth schematic diagram of an application scene of the virtual scene interaction data processing method according to some embodiments of this application. FIG. 4D shows a scene where the virtual object triggers the interaction control. In FIG. 4D, the virtual object 501 may interact with the interactive object 502 by triggering the interaction control 503.

In some embodiments, if the trigger operation of the player on an interaction button is received, and values in the three items completely meet the standard values, interaction actions are directly started to be played. The transformation process of these interaction actions collectively forms the transition animation seen by the virtual object after triggering the interaction.

In some embodiments, to avoid the case in which “the virtual object is excessively far from the standard interaction position, and when coordinate transformation is completed within one second, because the distance becomes long, the mean speed is excessively fast when the coordinate transformation is completed”, the maximum distance at which the virtual object can trigger the interaction may be set (i.e., a bevel edge length of a right triangle formed by the x-axis and the y-axis of the world displacement coordinates of the virtual object and the interaction position).

Referring to FIG. 4E, FIG. 4E is a fifth schematic diagram of an application scene of the virtual scene interaction data processing method according to some embodiments of this application. A is a standard position (the second position) where the interaction is triggered, C is a current position (the first position) of the virtual object, a length of AB is a difference in coordinates of the y-axis of A and B, a length of BC is a difference in coordinates of the x-axis of B and C, and a distance between the A and C is a length of a bevel edge AC of a triangle.

For example, by setting a threshold, the interaction control can be hidden from the virtual object when the AC length exceeds a certain limit, effectively preventing this case. For example, if the maximum movement speed of the virtual object in the game is set to 1000, it is required that the speed calculated as the length of AC per second (AC length/1 s) does not exceed 1000, namely, the AC length does not exceed 1000.

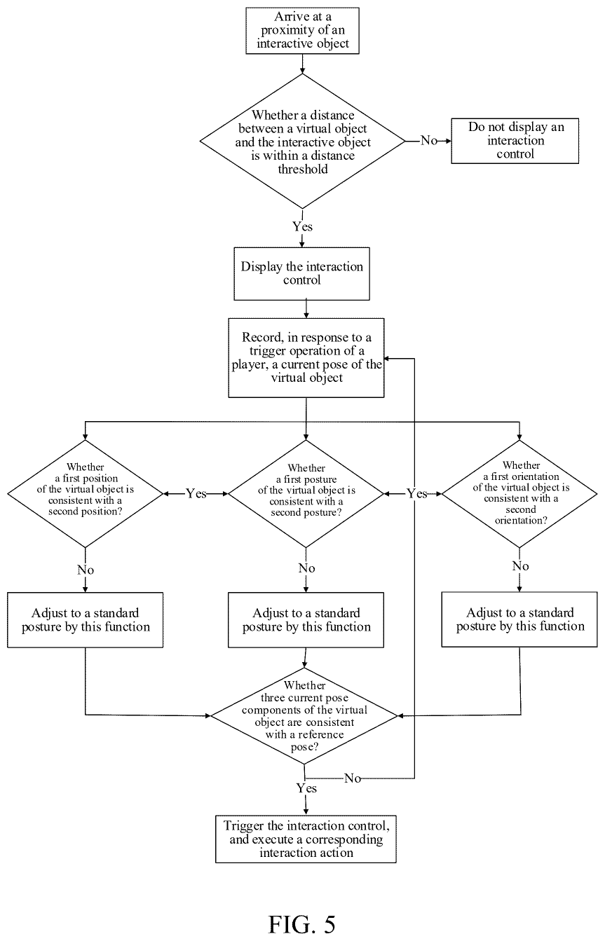

Referring to FIG. 5, FIG. 5 is a flowchart of an application scene of the virtual scene interaction data processing method according to some embodiments of this application.

Firstly, the virtual object reaches the proximity of the interactive object. It is determined whether the distance between the virtual object and the interactive object is within the distance threshold. If the distance between the virtual object and the interactive object is not within the distance threshold, the interaction control is not displayed, and if the distance between the virtual object and the interactive object is within the distance threshold, the interaction control is displayed.

Secondly, in response to the trigger operation performed by the player on the interaction control, the current pose of the virtual object clicking/tapping the interaction control is acquired, it is determined whether the first position, the first orientation, and the first posture of the virtual object are all consistent with the reference pose, and the inconsistent pose components are adjusted by the virtual scene interaction data processing method according to some embodiments of this application.

Finally, the adjusted data is determined again. When the current pose components are inconsistent with the reference pose, the data is recorded and adjusted again until all the current pose components are consistent with the reference pose. The interaction control is triggered, and the corresponding interaction actions are performed, to implement the interaction between the virtual object and the interactive object.

According to some embodiments of this application, by gradually transforming the current pose components of the virtual object at the first moment toward the reference pose at the second moment frame by frame, the interaction process between the virtual object and the interactive object becomes more natural. In addition, the virtual object is adjusted to the reference pose, making the triggering of the interaction control easier, thereby avoiding a plurality of triggers and reducing resource waste.

The following continues to describe that implementation of a virtual scene interaction data processing apparatus 455 provided in embodiments of this application is an example structure of a software module. In some embodiments, as shown in FIG. 2, software modules stored in the virtual scene interaction data processing apparatus 455 of a memory 440 may include:
a display module 4551, configured to display a virtual object and an interactive object in a virtual scene.

An acquiring module 4552, configured to, acquire, in response to the virtual object meeting, at a first moment, an interaction condition between the virtual object and the interactive object, a current pose of the virtual object at the first moment.

A first determining module 4553, configured to determine a pose difference value between the current pose and a reference pose, the reference pose being an initial pose of the virtual object during interaction with the interactive object.

A second determining module 4554, configured to determine a ratio of the pose difference value to a number of transition frames as a pose adjustment value, the number of transition frames being a number of image frames between the first moment and a second moment.

A data adjustment module 4555, configured to control the virtual object to implement, starting from the first moment, the pose adjustment value in each image frame until the second moment.

In some embodiments, the interaction condition includes: Meeting, by the virtual object at the first moment, that a distance between the virtual object and the interactive object is less than or equal to a distance threshold.

In some embodiments, a second moment is a moment after a preset duration has elapsed from the first moment, and the distance threshold is determined in following modes: acquiring a speed of the virtual object; and determining a product of the speed and the preset duration as the distance threshold.

In some embodiments, the preset duration is determined in any one of following modes: Selecting any duration in a preset duration selection range as the preset duration; determining the preset duration based on the speed of the virtual object, where the preset duration is positively correlated to the speed of the virtual object; and determining the preset duration based on a machine learning model, the machine learning model being trained by performing a following process: acquiring a training sample and label data, the training sample including video clips of a plurality of virtual scenes, a video clip of each virtual scene including a process of switching from a non-interactive state between the virtual object and the interactive object to an interactive state between the virtual object and the interactive object, and the label data representing a really calibrated preset duration; calling the machine learning model based on the training sample to obtain a prediction result; and determining a loss value based on the label data and the prediction result, and updating a parameter of the machine learning model based on the loss value to obtain a trained machine learning model.

In some embodiments, the interaction condition includes: receiving, at the first moment, operation instructions for triggering a control prop, the control prop being configured to control the interactive object to interact with the virtual object.

In some embodiments, the current pose includes following components: a first position, a first posture, and a first orientation of the virtual object at the first moment, and the reference pose includes following components: a second position, a second posture, and a second orientation of the virtual object during an interaction with the interactive object. The first determining module 4553 is further configured to determine a position difference value between a first position and a second position as the position difference value, determine a posture difference value between a first posture and a second posture as the posture difference value, determine an orientation difference value between a first orientation and a second orientation as the orientation difference value, and combine the position difference value, the posture difference value, and the orientation difference value into the pose difference value.

In some embodiments, the data adjustment module 4555 is further configured to determine a ratio of the position difference value to the number of transition frames as a position adjustment value; and control, in response to that the position adjustment value is a non-zero value, and based on a position where the virtual object is positioned at a root bone point in a previous frame, the virtual object to implement the position adjustment value in each image frame from the first moment to the second moment, to form a position in a current frame.

In some embodiments, the first position includes first plane coordinates of the virtual object corresponding to a world coordinate system at the first moment, the first plane coordinates include a first transverse coordinate and a first longitudinal coordinate, the second position includes second plane coordinates of the virtual object corresponding to the world coordinate system at the second moment, and the second plane coordinates include a second transverse coordinate and a second longitudinal coordinate; the data adjustment module 4555 is further configured to determine a difference in transverse coordinates between the first transverse coordinate and the second transverse coordinate, determine a ratio of the difference in transverse coordinates to the number of transition frames and take the ratio as a transverse position adjustment value, determine a difference in longitudinal coordinates between the first longitudinal coordinate and the second longitudinal coordinate, determine a ratio of the difference in longitudinal coordinates to the number of transition frames and take the ratio as a longitudinal position adjustment value, and control the virtual object to adjust a transverse position according to the transverse position adjustment value and adjust a longitudinal position according to the longitudinal position adjustment value.

In some embodiments, the data adjustment module 4555 is further configured to determine a ratio of the posture difference value to the number of transition frames and take the ratio as a posture adjustment value, and in response to that the posture adjustment value is a non-zero value, control the virtual object to implement the posture adjustment value in each image frame from the first moment to the second moment based on a posture of the virtual object in the previous frame, to form a posture in the current frame.

In some embodiments, the virtual object is in the prop-holding posture in the image frame at the first moment, and the virtual object is in the empty-handed posture in the image frame at the second moment.

In some embodiments, the data adjustment module 4555 is further configured to when current pose components include the first orientation, determine a ratio of the orientation difference value to the number of transition frames and take the ratio as an orientation adjustment value, and in response to that the orientation adjustment value is a non-zero value, control the virtual object to implement the orientation adjustment value in each image frame from the first moment to the second moment based on an orientation of a root bone of the virtual object in the previous frame to form an orientation in the current frame.

In some embodiments, the first orientation includes first rotation coordinates of the virtual object corresponding to the world coordinate system at the first moment, and the second orientation includes second rotation coordinates of the virtual object corresponding to the world coordinate system at the second moment. The data adjustment module 4555 is further configured to determine a difference in rotation coordinates between the first rotation coordinate and the second rotational coordinate, determine a ratio of the difference in rotation coordinates to the number of transition frames as the orientation adjustment value, and control the virtual object to rotate the orientation adjustment value around a vertical reference axis of the world coordinate system according to the orientation adjustment value, the vertical reference axis being perpendicular to a plane of the world coordinate system.

In some embodiments, the data adjustment module 4555 is further configured to, in response to an interaction condition being not met, shield display of an interaction control of the interactive object, and start to display, in response to the interaction condition being met, and from the first moment, the interaction control of the interactive object.

In some embodiments, the data adjustment module 4555 is further configured to control, after controlling the virtual object to implement, starting from the first moment, the pose adjustment value in each image frame until the second moment, the interactive object to interact with the virtual object in response to a trigger operation for the interaction control.

In some embodiments, the interactive object includes the interaction control, where in response to that the interaction condition is not met, the interaction control is in an un-triggerable state, and in response to that the interaction condition is met, the interaction control is in a triggerable state.

In some embodiments, the data adjustment module 4555 is further configured to shield, in response to that a pose of the virtual object at the second moment is different from a preset standard pose, display of the interaction control of the interactive object, and display, in response to that the pose of the virtual object at the second moment is the same as the preset standard pose, the interaction control of the interactive object at the second moment.

Embodiments of this application provide a computer program product, the computer program product including a computer program or computer-executable instructions, the computer program or the computer-executable instructions being stored in a computer-readable storage medium. A processor of an electronic device reads the computer-executable instructions from the computer-readable storage medium, and the processor executes the computer-executable instructions, so that the electronic device performs the virtual scene interaction data processing method according to some embodiments of this application.

Some embodiments of this application provide a computer-readable storage medium, having computer-executable instructions or a computer program stored therein. When the computer-executable instructions or the computer program is executed by a processor, the processor is enabled to perform the virtual scene interaction data processing method provided in some embodiments of this application, for example, the virtual scene interaction data processing method shown in FIG. 3A.

In some embodiments, the computer-readable storage medium may be a memory such as an RAM, an ROM, a flash memory, a magnetic surface memory, an optical disc, or a CD-ROM, or may be various devices including one or any combination of the memories.

In some embodiments, the computer-executable instructions may be written in any form of programming language (including a compiled or interpreted language, or a declarative or procedural language) in a form of a program, software, a software module, a script, or code, and may be deployed in any form, including being deployed as an independent program or being deployed as a module, a component, a subroutine, or another unit applicable for use in a computing environment.

For example, the computer-executable instructions may, but do not necessarily correspond to a file in a file system, and may be stored as a part of a file that saves another program or data, for example, stored in one or more scripts in a hyper text markup language (HTML) file, stored in a single file dedicated to a program in discussion, or stored in a plurality of collaborative files (for example, files that store one or more modules, subprograms, or code parts).

For example, the computer-executable instructions may be deployed to be executed on one electronic device, or executed on a plurality of electronic devices located at one position, or executed on a plurality of electronic devices that are distributed in a plurality of positions and interconnected by a communication network.

In summary, according to some embodiments of this application, through gradual transforming of the current pose components of the virtual object at the first moment to the reference pose at the second moment frame by frame, the interaction process between the virtual object and the interactive object becomes more natural. In addition, the virtual object is adjusted to the reference pose, making the triggering of the interaction control easier, thereby avoiding a plurality of triggers and reducing resource waste.

The foregoing descriptions are merely examples of some embodiments of this application, and this is not intended to limit the protection scope of this application. Any modification, equivalent replacement, improvement, and the like made within the spirit and scope of this application are to fall within the protection scope of this application.

What is claimed is:

1. A virtual scene interaction data processing method, the method being executed by an electronic device, and comprising:
displaying a virtual object and an interactive object in a virtual scene;
acquiring a current pose of the virtual object at a first moment, in response to the virtual object meeting, at the first moment, an interaction condition between the virtual object and the interactive object;
determining a pose difference value between the current pose and a reference pose, the reference pose being an initial pose of the virtual object during interaction with the interactive object;
determining a ratio of the pose difference value to a number of transition frames as a pose adjustment value, the number of transition frames being a number of image frames between the first moment and a second moment; and
controlling the virtual object to implement, starting from the first moment, the pose adjustment value in each image frame until the second moment.

2. The method according to claim 1, wherein the interaction condition comprises:
that a distance between the virtual object and the interactive object is less than or equal to a distance threshold.

3. The method according to claim 2, wherein the second moment is a moment after a preset duration has elapsed from the first moment, and the method further comprises:
determining the distance threshold in following modes:
acquiring a speed of the virtual object; and
determining a product of the speed and the preset duration as the distance threshold.

4. The method according to claim 3, wherein the method further comprises:
determining the second position in any one of following modes:
selecting any duration in a preset duration selection range as the preset duration;
determining the preset duration based on the speed of the virtual object, wherein the preset duration is positively correlated to the speed of the virtual object; and
determining the preset duration based on a machine learning model, the machine learning model being trained by performing:
acquiring a training sample and label data, the training sample comprising video clips of a plurality of virtual scenes, a video clip of each virtual scene comprising a process of switching from a non-interactive state between the virtual object and the interactive object to an interactive state between the virtual object and the interactive object, and the label data representing a really calibrated preset duration; calling the machine learning model based on the training sample to obtain a prediction result; and determining a loss value based on the label data and the prediction result, and updating a parameter of the machine learning model based on the loss value to obtain a trained machine learning model.

5. The method according to claim 1, wherein the interaction condition comprises:
receiving operation instructions for triggering a control prop at the first moment, the control prop being configured to control the interactive object to interact with the virtual object.

6. The method according to any one of claims 1, wherein
the current pose comprises: a first position, a first posture, and a first orientation of the virtual object at the first moment, and the reference pose comprises following components: a second position, a second posture, and a second orientation of the virtual object during an interaction with the interactive object; and
the determining a pose difference value between the current pose and a reference pose comprises:
determining a position difference value between the first position and the second position as the position difference value;
determining a posture difference value between the first posture and the second posture as the posture difference value;
determining an orientation difference value between the first orientation and the second orientation as the orientation difference value; and
combining the position difference value, the posture difference value, and the orientation difference value into the pose difference value.

7. The method according to claim 1, wherein when the current pose components comprise the first position, the controlling the virtual object to implement, starting from the first moment, the pose adjustment value in each image frame until the second moment comprises:
determining a ratio of the position difference value to the number of transition frames as a position adjustment value; and
controlling the virtual object to implement the position adjustment value in each image frame from the first moment to the second moment, to form a position in a current frame, in response to that the position adjustment value is a non-zero value, and based on a position where the virtual object is positioned at a root bone point in a previous frame.

8. The method according to claim 7, wherein
the first position comprises first plane coordinates of the virtual object corresponding to a world coordinate system at the first moment, the first plane coordinates comprise a first transverse coordinate and a first longitudinal coordinate, the second position comprises second plane coordinates of the virtual object corresponding to the world coordinate system at the second moment, and the second plane coordinates comprise a second transverse coordinate and a second longitudinal coordinate; and
the controlling the virtual object to implement the position adjustment value comprises:
determining a difference in transverse coordinates between the first transverse coordinate and the second transverse coordinate;
determining a ratio of the difference in transverse coordinates to the number of transition frames as a transverse position adjustment value;
determining a difference in longitudinal coordinates between the first longitudinal coordinate and the second longitudinal coordinate;
determining a ratio of the difference in longitudinal coordinates to the number of transition frames as a longitudinal position adjustment value; and
controlling the virtual object to adjust a transverse position according to the transverse position adjustment value, and adjust a longitudinal position according to the longitudinal position adjustment value.

9. The method according to claim 1, wherein when the current pose components comprise the first posture, the controlling the virtual object to implement, starting from the first moment, the pose adjustment value in each image frame until the second moment comprises:
determining a ratio of the posture difference value to the number of transition frames as a posture adjustment value; and
controlling the virtual object to implement the posture adjustment value in each image frame from the first moment to the second moment, to form a posture in a current frame in response to that the posture adjustment value is a non-zero value, and based on a posture of the virtual object in a previous frame,.

10. The method according to claim 9, wherein
the virtual object is in a prop-holding posture in the image frame at the first moment, and the virtual object is in an empty-handed posture in the image frame at the second moment.

11. The method according to claim 1, wherein when the current pose components comprise the first posture, the controlling the virtual object to implement, starting from the first moment, the pose adjustment value in each image frame comprises:
determining a ratio of the orientation difference value to the number of transition frames as an orientation adjustment value; and
controlling the virtual object to implement the orientation adjustment value in each image frame from the first moment to the second moment, to form an orientation in a current frame, in response to that the orientation adjustment value is a non-zero value, and based on an orientation of a root bone of the virtual object in a previous frame,.

12. The method according to claim 11, wherein
the first orientation comprises first rotation coordinates of the virtual object corresponding to a world coordinate system at the first moment, and the second orientation comprises second rotation coordinates of the virtual object corresponding to the world coordinate system at the second moment; and
the controlling the virtual object to implement the orientation adjustment value comprises:
determining a difference in rotation coordinates between the first rotation coordinate and the second rotation coordinate;
determining a ratio of the difference in rotation coordinates to the number of transition frames as the orientation adjustment value; and
controlling the virtual object to rotate the orientation adjustment value around a vertical reference axis of the world coordinate system according to the orientation adjustment value, the vertical reference axis being perpendicular to a plane of the world coordinate system.

13. The method according to claim 1, wherein the method further comprises:
shielding display of an interaction control of the interactive object in response to the interaction condition being not met,; and
displaying the interaction control of the interactive object in response to the interaction condition being met, and from the first moment.

14. The method according to claim 13, wherein after the controlling the virtual object to implement, starting from the first moment, the pose adjustment value in each image frame until the second moment, the method further comprises:
controlling the interactive object to interact with the virtual object in response to a trigger operation for the interaction control,.

15. The method according to claim 1, wherein the interactive object comprises the interaction control, and the method further comprises:
setting the interaction control into an un-triggerable state in response to the interaction condition not being met; and
setting the interaction control into a triggerable state in response to the interaction condition being met,.

16. The method according to claim 1, wherein after the controlling the virtual object to implement, starting from the first moment, the pose adjustment value in each image frame until the second moment, the method further comprises:
shielding display of the interaction control of the interactive object in response to that a pose of the virtual object at the second moment is different from a preset standard pose, ; and
displaying the interaction control of the interactive object at the second moment in response to that the pose of the virtual object at the second moment is the same as the preset standard pose.

17. An electronic device, comprising:
a memory, configured to store computer-executable instructions; and
a processor, configured to implement a virtual scene interaction data processing method when executing the computer-executable instructions stored in the memory, the method comprising:
displaying a virtual object and an interactive object in a virtual scene;
acquiring a current pose of the virtual object at a first moment, in response to the virtual object meeting, at the first moment, an interaction condition between the virtual object and the interactive object;
determining a pose difference value between the current pose and a reference pose, the reference pose being an initial pose of the virtual object during interaction with the interactive object;
determining a ratio of the pose difference value to a number of transition frames as a pose adjustment value, the number of transition frames being a number of image frames between the first moment and a second moment; and
controlling the virtual object to implement, starting from the first moment, the pose adjustment value in each image frame until the second moment.

18. The electronic device according to claim 17, wherein the interaction condition comprises:
that a distance between the virtual object and the interactive object is less than or equal to a distance threshold.

19. A non-transitory computer-readable storage medium, having computer-executable instructions or a computer program stored therein, when the computer-executable instructions or the computer program being executed by a processor, a virtual scene interaction data processing method comprising:
displaying a virtual object and an interactive object in a virtual scene;
acquiring a current pose of the virtual object at a first moment, in response to the virtual object meeting, at the first moment, an interaction condition between the virtual object and the interactive object;
determining a pose difference value between the current pose and a reference pose, the reference pose being an initial pose of the virtual object during interaction with the interactive object;
determining a ratio of the pose difference value to a number of transition frames as a pose adjustment value, the number of transition frames being a number of image frames between the first moment and a second moment; and
controlling the virtual object to implement, starting from the first moment, the pose adjustment value in each image frame until the second moment.

20. The computer-readable storage medium according to claim 19, wherein the interaction condition comprises:
that a distance between the virtual object and the interactive object is less than or equal to a distance threshold.
